(19) United States
(12) Patent Application Publication
(10) Pub. No.: US 2022/0111828 A1
(43) Pub. Date: Apr. 14, 2022

(54) Method for Operating a Hybrid Electric Motor Vehicle, Control Device and Hybrid Electric Motor Vehicle

(71) Applicant: Bayerische Motoren Werke Aktiengesellschaft, Muenchen (DE)

(72) Inventors: Johannes BUERGER, Muenchen (DE); Roland SCHMID, Muenchen (DE)

(21) Appl. No.: 17/417,534

(22) PCT Filed: Jan. 20, 2020
(86) PCT No.: PCT/EP2020/051224

§ 371 Date: Jun. 23, 2021

(30) Foreign Application Priority Data
Feb. 14, 2019 (DE) 10 2019 103 689.5

(51) Int. Cl. B60W 20/12

(52) U.S. Cl. CPC B60W 20/12; B60W 2510/244; B60W 2555/60; B60W 2540/215; B60W 2540/30; B60W 2552/35; B60W 2555/20; B60W 2710/1005; B60W 2552/15

(57) ABSTRACT

A method for operating a hybrid electric motor vehicle, having an electric drive unit and a combustion-engine-powered drive unit, on a driving route is provided. The method includes dividing the driving route into route segments; rule-based classifying of the route segments as first route segments to be travelled in an electrically powered manner or second route segments to be travelled in a hybrid-powered manner; predicting an electrical energy to be required for the first route segments and to be provided by an electrical energy accumulator of the electrical drive unit; determining a remaining energy for the second route segments according to the electrical energy required for the first route segments; and optimization-based and rule-based determining of a load point distribution between the electrical drive unit and the combustion-engine-powered drive unit in the second route segments.

### BACKGROUND AND SUMMARY OF THE INVENTION

The invention relates to a method for operating a hybrid electric motor vehicle, having an electric drive unit and a combustion-engine-powered drive unit, on a driving route. The invention also relates to a control device and to a hybrid electric motor vehicle.

The focus here is on parallel hybrid drives or hybrid drive trains for hybrid electric motor vehicles, referred to as hybrid vehicles for short. Such hybrid vehicles have an electric drive unit with an electrical energy store and an electric machine and an electric motor as well as a combustion-engine-powered drive unit with a fuel-operated combustion engine. Such a hybrid drive train provides the possibility of reducing fuel consumption of the hybrid vehicle through the targeted use of the electrical energy which is provided by the energy store. For this purpose, the hybrid vehicle can be operated in a hybrid driving mode and a load point of the hybrid vehicle, that is to say the distribution of the power required by the hybrid vehicle, between the combustion engine and the electric motor, can be adjusted. This makes it possible to ensure that the hybrid vehicle is operated in a way which is optimum in terms of fuel. Furthermore, depending on the drive architecture of the hybrid drive train, it is possible to selectively switch off the combustion engine and provide a purely electric driving mode by way of the electric motor which is supplied by the energy store. In this way, the fuel consumption can be reduced further.

In this context, it is known from the related art to determine the load points in the hybrid driving modes and the purely electric driving modes on a driving route by way of different operating strategies, specifically a rule-based and characteristic-diagram-based operating strategy or an optimization-based operating strategy. Document DE 10 2016 206 727 A1 is known with respect to the rule-based and characteristic-diagram-based operating strategy, the document disclosing predictive operation of a hybrid vehicle on a driving route. In this context, the driving route is divided, on the basis of digital map information, into a sequence of segments, and a sequence of driving modes is obtained for the corresponding sequence of segments. The driving modes differ here with respect to the consumption of electrical energy from an electrical energy store of the vehicle. One driving mode defines one or more characteristic curves which indicate the velocity, the required drive and/or the state of charge with which a combustion-engine-powered drive, that is to say a combustion engine, of the hybrid vehicle is activated. The one or more characteristic curves can therefore be used to define the distribution between the combustion-engine-powered drive unit and the electric drive unit.

These characteristic curves are generally optimized, defined and applied in advance on the basis of specific representative driving cycles. In this way, they have an optimum behavior for the respectively considered driving situations. However, customer cycles differ from these driving cycles which are considered in advance, as a result of which the characteristic diagrams which are defined in advance can no longer bring about optimum behavior. The full potential of plug-in hybrid vehicles is therefore not completely utilized.

Optimization-based operating strategies, on the other hand, are based on mathematical optimization methods and therefore ensure that the hybrid vehicle is operated in a way which is optimum in terms of fuel. However, the disadvantage of such operating strategies is that the optimization method cannot take any account at all of a driving behaviour which is desired by the customer or driving comfort which is desired by the customer.

An object of the present invention is to provide a strategy for operating a hybrid vehicle which is improved in comparison with the related art.

This object is achieved according to the claimed invention.

A method according to embodiments of the invention serves to operate a hybrid electric motor vehicle which has an electric drive unit and a combustion-engine-powered drive unit, on a driving route. For this purpose, the driving route is divided into route segments, and the route segments are classified in a rule-based fashion as first route segments which are to be driven along electrically or second route segments which can be driven along in hybrid mode. For first route segments, a necessary amount of electrical energy which is to be provided by an electrical energy store of the electric drive unit is predicted, and an amount of residual energy is determined for the second route segments in accordance with the electrical energy which is necessary for the first route segments. Moreover, the electrical energy for the second route segments is determined in an optimization-based fashion while minimizing the fuel consumption of a combustion engine of the combustion-engine-powered drive unit, in accordance with the residual energy of the electrical energy store and in accordance with limiting start/stop processes of the combustion engine.

The invention also relates to a control device for a hybrid electric vehicle which is configured to carry out a method according to the invention or an advantageous embodiment thereof. Furthermore, a hybrid electric motor vehicle according to embodiments of the invention comprises a control device according to embodiments of the invention.

The hybrid electric motor vehicle, hybrid vehicle for short, has the electric drive unit with the electrical energy store and the electric machine as well as the combustion-engine-powered drive unit with a fuel tank and the combustion engine. The hybrid vehicle is, in particular, a plug-in hybrid vehicle, so that the electrical energy store of the electric drive unit can be charged by way of a charging station which is external to the vehicle. The hybrid vehicle has in this context a parallel drive train and can be operated in a purely electric driving mode in that only the electric drive unit acts on a drive axle drive train and makes available a drive power for the hybrid vehicle. For this purpose, the combustion-engine-powered drive unit can be decoupled from the drive axle of the hybrid vehicle. The electrical energy store is for this purpose embodied, in particular, as a high-voltage battery or traction battery. The hybrid vehicle can also be operated in a hybrid driving mode in which, as an alternative to or in addition to the electric drive unit, the combustion-engine-powered drive unit acts on the drive axle and provides drive power for the hybrid vehicle.

In order to determine when the purely electric drive mode and when the hybrid driving mode are provided, the driving route to be driven along by the hybrid vehicle is firstly proportioned or divided into the route segments. The division of the driving route into the route segments is preferably carried out in accordance with navigation data of a navigation system of the hybrid electric vehicle. The driving route can be predicted, for example, on the basis of a destination input by a driver of the hybrid vehicle into the navigation system. Each route segment has at least one route point in this context.

For each route segment it is determined here whether it is to be driven along electrically, that is to say whether an electric driving mode is obligatory, or whether the route segment can also be driven along in hybrid mode and therefore the hybrid driving mode can be provided. This classification or division of the route segments into route segments which are to be driven along electrically and route segments which are to be driven along in hybrid mode is carried out in a rule-based fashion here. In particular, a rule-based specification and/or a driver's request-specific input is taken into account for the rule-based classification. For example, what are referred to as e-zones, that is to say areas in which motor vehicles are to be operated only in a purely electric fashion, and therefore without emissions, can be located on the driving route owing to legal specifications. Such e-zones can be present, for example, in city centers and/or at traffic points which have a high volume of traffic. Alternatively or additionally the driver can use the driver's-request-specific input to define specific areas in which the driver wishes to have a purely electric driving mode of the hybrid vehicle. Such areas may be, for example, residential areas, city center areas etc. If it is then detected that a specific route segment lies in an e-zone or in an area which is defined by the driver, this route segment is defined or classified as a first route segment which is to be driven along electrically.

The other route segments, which do not have to be driven along purely electrically, are defined as second route segments which can be driven along in hybrid mode. In these second route segments the drive power for the hybrid vehicle can be provided by the electric drive unit and/or the combustion-engine-powered drive unit. Therefore, in the route segments which can be driven along in hybrid mode the drive power can be apportioned as desired between the electric drive unit and the combustion-engine-powered drive unit. For example, a portion x which the electric drive unit contributes to the drive power can be between x=0% and x=100%, wherein a portion y which the combustion-engine-powered drive unit contributes to the drive power is y=100%-x. The proportion of the drive power between the electric drive unit and the combustion-engine-powered drive unit over the route segment corresponds here to shifting of the load point.

Since the electrical energy store of the hybrid vehicle is discharged in the first route segment owing to the purely electric drive mode, electrical residual energy which is available for the second route segment which can be driven along in hybrid mode occurs in accordance with an initial state of charge of the electrical energy store and a number and a period of the first route segments. The residual energy is an energy delta or an energy difference between initial energy which corresponds to the initial state of charge and the energy which is necessary for the first route segments. This electrical residual energy is divided at least partially between the second route segments which can be driven along in hybrid mode. A portion which the electric drive unit contributes to the drive power is therefore determined for each route segment. For example, further e-driving times, that is to say route segments which can be driven along in a purely electric mode, can be determined in the second route segments.

The electrical energy, which corresponds at maximum to the available residual energy, is distributed in such a way that on the one hand the fuel consumption is optimal, in particular minimal, in each second route segment, and on the other hand start/stop processes, in particular high-frequency start/stop processes, of the combustion engine are limited, in particular minimized. By determining the shifting of the load points it is possible to make a purely electric driving decision for specific second route segments, while for other second route segments a route-segment-specific load point is determined, by way of which load point the drive power is provided both by the combustion engine and the electric machine. In the case of a start/stop process of the combustion engine the latter is activated and deactivated. The combustion engine is, for example, activated whenever the operation of the hybrid vehicle changes from the purely electric driving mode into the hybrid driving mode or when the hybrid vehicle drives off from a stationary state, for example at a set of traffic lights, and is, for example, shut down when the operation of the hybrid vehicle changes from the hybrid drive mode into the purely electric driving mode or the hybrid vehicle comes to a standstill. When the internal combustion engine is activated, both electrical energy and fuel are necessary until the combustion engine has reached a certain rotational speed which is necessary for the activation. Therefore it may be the case that with respect to the consumption of energy and fuel it is not beneficial to carry out a start/stop process of the combustion engine. Furthermore, start/stop processes of the combustion engine are noticed by the driver of the hybrid vehicle, and if they occur frequently and in rapid succession one after the other or with a high frequency they can be perceived as an unstable engine behavior and have an adverse effect on the comfort of the driver.

Purely optimization-based shifting of the load point or distribution of the electrical energy on the second route segments, that is to say an exclusively fuel-optimal approaching strategy, without taking into account the start/stop processes of the combustion engine, could result in start/stop processes appearing often and/or with a high frequency in the route segments which can be driven along in hybrid mode. In the case of the high-frequency start/stop processes, start processes and stop processes occur a short time after one another. In order to prevent this frequency of the start/stop processes having an adverse effect on both the energy and fuel consumption and on the comfort, the start/stop processes are limited to the second route segments during the apportioning of the electrical energy. Limitation of the start/stop processes is to be understood here as meaning both a reduction in an, in particular absolute, number as well as the frequency of the start/stop processes.

The apportioning of the electrical energy while minimizing the fuel consumption corresponds here to an optimization-based strategy or consumption optimization, while the classification of the route segments corresponds to a rule-based operating strategy. Taking into account the start/stop processes can be implemented both in an optimization-based and rule-based fashion. The method according to embodiments of the invention therefore combines the optimization-based and the rule-based operating strategy or integrates the rule-based operating strategy into the optimization-based operating strategy. Therefore, the method according to embodiments of the invention has the advantage that it is possible both to minimize the fuel consumption and to take into account secondary conditions in the form of the purely electric drive mode and the limited start/stop processes of the combustion engine. The secondary conditions therefore make it possible to take into account behavior of the hybrid vehicle which is close to reality in the optimization of the consumption, while taking into account consumption conditions and comfort conditions. The method according to embodiments of the invention therefore provides the driver of the hybrid vehicle with both consumption advantages and advantages in respect of comfort.

It is possible to provide in this context that in order to operate the hybrid electric motor vehicle on the driving route an optimum control function for the driving units of the hybrid electric motor vehicle is determined and for this purpose an optimization function which minimizes the fuel consumption is executed over the route segments, wherein during the execution of the optimization function a rule-based definition of the degree of freedom which prevents the optimization-based proportion of the electric energy and a cost function for the start/stop processes are taken into account in specific route segments. The optimization function is executed here, in particular globally, over the route segments, for example by way of a computation-efficient and real-time-capable optimization algorithm, wherein the classification of the route segment and the limitation of the start/stop processes are carried out at the same time as the execution of the optimization function. The classification is carried out here by virtue of the fact that the definition of the degree of freedom is performed in a rule-based fashion on those route segments which are driven along purely electrically. In these route segments, the shifting of the load point is therefore prohibited and the provision of the drive power is therefore assigned completely to the electric drive unit. The limitation of the start/stop processes is carried out by assigning costs to the start/stop processes. The costs are taken into account by way of the cost function or penalty function. The cost function and the definitions of the degrees of freedom serve here as an input variable for the optimization algorithm or the optimization function. The output variable of the optimization function is fuel-optimal control for the drive units, which additionally takes into account legal and/or driver-defined e-driving zones and ensures stable start/stop behavior of the combustion engine.

In one development of the invention, at least one condition which relates to the driving route, in particular a route-segment-specific condition of the roadway and/or a route-segment-specific gradient of the roadway and/or a route-segment-specific speed limit are additionally taken into account during the optimization-based determination of the shifting of the load point or a portion of the electrical energy. The at least one condition which relates to the driving route is determined here in particular in a predictive fashion. For example, the at least one condition is determined on the basis of digital map information which is stored for the navigation system of the hybrid vehicle. A prediction is therefore produced over the driving route, for example in order to find out those route segments in which a purely electric driving mode would be inefficient and result in an undesirably high consumption of energy. This undesirably high consumption of energy can result, for example, from a steep gradient of the roadway, e.g. in the case of uphill travel, in specific route segments. For these route segments, the hybrid driving mode can then be specified and determined, for example as a further input variable for the optimization function, such that the combustion-engine-powered drive unit provides a minimum portion of the drive power. It can also be the case that the at least one condition is determined while the hybrid vehicle is driving on the driving route or is determined again for the purpose of updating. For example, the at least one condition can be determined by way of sensor data of a vehicle-side sensor device during travel, and the optimum control function can be adapted during travel.

Moreover, there can be provision that during optimization-based apportioning of the electrical energy at least one ambient condition, in particular an ambient temperature and/or a time of day and/or the weather, are/is additionally taken into account. These ambient conditions particularly influence the energy consumption of on-board power system components of the hybrid vehicle. Such on-board power system components can be, for example, a heating system, an air-conditioning system, headlight, windshield wiper etc. and can be supplied with energy from the electrical energy store of the electric drive unit. Depending on the ambient condition, these on-board power system components can be partially active and as a result consume a quantity of energy which is dependent on at least one ambient condition and which has to be kept available by the energy store. The at least one ambient condition can in turn be determined predictively and/or during travel and provided as a further input variable for the optimization function.

In a further embodiment of the invention, a physical model of the electric drive unit and/or a physical model of the combustion-engine-powered drive unit of the hybrid electric motor vehicle are/is additionally taken into account in the optimization-based apportioning of the electrical energy. These physical models can, for example, take into account losses in the electric and/or combustion-engine-powered drive unit. Design limits for the drive components of the electric drive unit and/or of the combustion-engine-powered drive unit can also be stored in these models. For example, limits on the state of charge of the electrical energy store can be taken into account in this way. The physical models can be stored, for example, in the form of characteristic diagrams for the drive components, that is to say combustion engine, electric motor, energy store etc. For example, such a characteristic diagram can describe the losses of the combustion engine as a function of the rotational speed. These models in turn form further rule-based input variables for the determination of the control function. The rule-based, fuel-optimal control of the drive units therefore advantageously additionally ensures low-wear operation of the drive components of the drive units.

It proves advantageous if high-frequency shifting processes for a transmission of the hybrid electric motor vehicle are additionally limited during the optimization-based distribution of the electrical energy. The shifting processes can in turn entail costs which are described by a further cost function. This further cost function can form a further input variable for the optimization algorithm.

There can also be provision that a predetermined, requested final state of charge of the electrical energy store at the end of the driving route is additionally taken into account in the optimization-based apportioning of the electrical energy. The electrical energy which is available for the apportioning between the route segments which can be driven along in a hybrid mode is therefore the residual energy minus the electrical energy which is necessary to maintain the final state of charge. The residual energy can therefore be only partially distributed between the route segments which can be driven on in hybrid mode. For example, the state of discharge which is different from zero can be requested when there is no possibility available for charging the electrical energy store at the end of the driving route. The requested state of discharge can be determined, for example, as a value by which a predetermined route can still be driven along purely electrically. It can therefore be ensured that when renewed travel occurs the hybrid vehicle can still be driven through a legally prescribed e-zone which starts from the end of the driving route, before the energy store has to be charged. This provides further advantages in respect of convenience for the driver of the hybrid vehicle.

In one development of the invention a driving style of the driver of the hybrid electric motor vehicle is additionally taken into account during the optimization-based apportioning of the electrical energy. The driving style of the driver can also be stored in characteristic diagrams and describe, for example, an acceleration behavior and a recuperation behavior of the driver. When there are strong acceleration processes, the electric machine assists the combustion engine and therefore provides a boost function. As a result, the energy store is discharged. When the hybrid vehicle is braked, the energy store is charged by way of recuperation. Continuous acceleration and braking of the hybrid vehicle brings about high-frequency charging and discharging of the energy store. This results in more rapid aging of the energy store and therefore has an adverse effect on the service life and on the electrical range of the hybrid vehicle. Taking into account the driving style or driving behavior of the driver in the shifting of the load point can therefore provide particularly low-wear operation of the energy store. The driving behavior can be recorded, stored and continuously updated, for example, during journeys of the hybrid vehicle. The embodiments which are presented with respect to the method according to the invention, and the advantages of the embodiments, apply correspondingly to the control device according to the invention and to the hybrid electric motor vehicle according to the invention.

Further features of the invention emerge from the claims, figures and the description of the figures. The features and combinations of features which are mentioned in the description and the features and combination of features which are mentioned below in the description of the figures and/or only shown in the figures can be used not only in the respectively indicated combination but also in other combinations or alone.

The invention will now be explained in more detail on the basis of a preferred exemplary embodiment and with reference to the drawings.

### BRIEF DESCRIPTION OF THE DRAWINGS

FIG. 1 shows a schematic illustration of a hybrid drive of an embodiment of a hybrid electric motor vehicle according to the invention.

FIG. 2 shows a schematic illustration of a sequence of an embodiment of the method according to the invention.

### DETAILED DESCRIPTION OF THE DRAWINGS

Identical and functionally identical elements are provided with the same reference symbols in the figures.

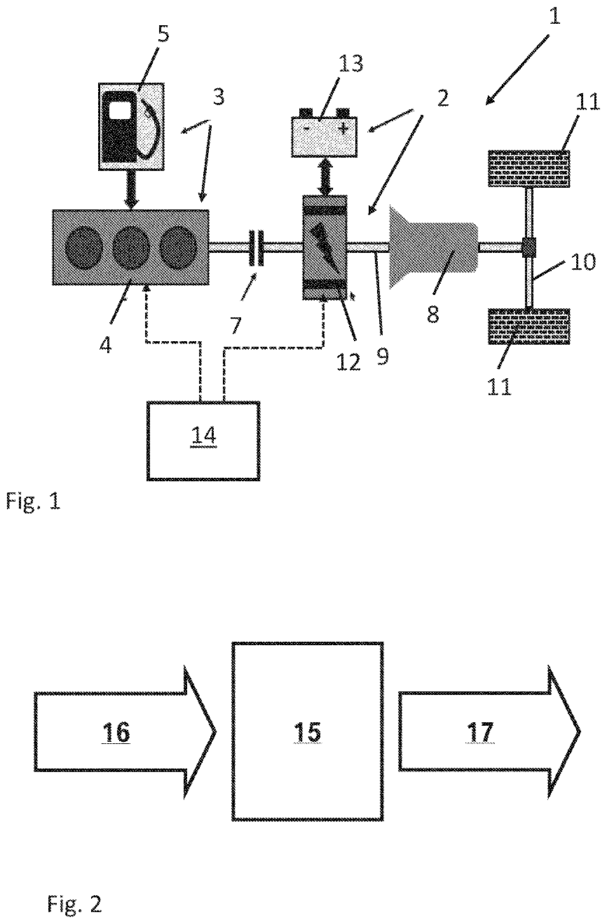

FIG. 1 shows a schematic illustration of a hybrid drive 1 for a hybrid electric motor vehicle. The hybrid drive 1 has a parallel drive train with an electric drive unit 2 and a combustion-engine-powered drive unit 3. The combustion-engine-powered drive unit 3 has a combustion engine 4 and a fuel tank 5 which is coupled to the combustion engine 4. The combustion engine 4 is coupled to a clutch 7 by a crankshaft 6. The clutch 7 is coupled to a transmission 8 which is coupled to a drive axle 10 of the hybrid vehicle via a drive shaft 9. The drive axle 10 is configured to transmit the torque, provided by the combustion engine 4, to wheels 11 of the hybrid vehicle.

The electric drive unit 2 has an electric machine 12 which is arranged here on the drive shaft 9 and is separated from the combustion engine 4 by the clutch 7. The combustion engine 4 can therefore be decoupled from the electric machine 12. When the combustion engine 4 is coupled, the electric machine 12 can provide a torque in addition to the combustion engine 4, or as an alternative to the combustion engine 4 when the combustion engine 4 is decoupled, the torque being transmitted to the wheels 11 via the clutch 7, the transmission 8, the drive shaft 9 and the drive axle 10. The electric machine 12 is supplied with electrical energy by an electrical energy store 13 of the electric drive unit 2. The electric machine 12 can be, for example, a three-phase machine and can be connected to the electrical energy store 13 via an inverter (not shown) which converts the direct current provided by the electric energy store 13 into a three phase current. The electrical energy store 13 is embodied, in particular, as a high-voltage store or a high-voltage battery and therefore has a voltage which is higher than 60 V, in particular higher than 100 V. The hybrid drive 1 also has a control device 14 which is configured to actuate the electric drive unit 2 and the combustion-engine-powered drive unit 3 in order to operate the hybrid vehicle on a driving route. For this purpose, a control function for the drive units 2, 3 is determined, by way of which function the hybrid vehicle is operated in a fuel-optimal fashion under specific boundary conditions.

FIG. 2 illustrates the determination of the control function. A computationally efficient and real-time-enabled optimization algorithm is represented in the center by the box 15, the algorithm determining the control function for each route segment of the driving route in such a way that the fuel consumption is minimal. The optimization algorithm is additionally fed with input variables, which are represented by the arrow 16 and are taken into account during the minimization of the fuel consumption. The input variables are here, inter alia, definitions of degrees of freedom, which specifies certain route segments as route segments which are to be driven on purely electrically. As soon as the hybrid vehicle enters this route segment which is to be driven along purely electrically, the combustion engine 4 is deactivated by the control device 14, and the hybrid vehicle is therefore operated purely electrically. These route segments which are to be driven along purely electrically are present, for example, owing to legal requirements or owing to a definition made by the driver of the hybrid vehicle.

Further input variables are cost functions by which costs are assigned to start/stop processes of the combustion engine 4 and to shift processes of the transmission 8. These cost functions, with the minimization of fuel consumption, simultaneously result in a limiting of start/stop processes of the combustion engine 4 as well as shift processes of the transmission 8. Additionally, physical models, which describe behavior of the electric drive unit 2 and of the combustion-engine-powered drive unit 3 which is close to reality can be taken into account as input variables. Furthermore, ambient conditions and roadway conditions on the driving route can be predicted and/or determined during the travel of the hybrid vehicle and taken into account as input variables. A driving behavior which affect charging and discharging processes of the energy store 13 can be provided as an input variable to the optimization algorithm. The result of the optimization algorithm, indicated by the arrow 17, is fuel-optimal operation of the hybrid vehicle which ensures, inter alia, obligatory purely electric journeys in specific route segments and a stable, comfortable start/stop behavior of the combustion engine 4.

### LIST OF REFERENCE NUMBERS

1 Hybrid drive
2 Electric drive unit
3 Combustion-engine-powered drive unit
4 Combustion engine
5 Fuel tank
6 Crankshaft
7 Clutch
8 Transmission
9 Drive shaft
10 Drive axle
11 Wheels
12 Electric machine
13 Electrical energy store
14 Control device
15 Box
16 Arrow
17 Arrow

1.-12. (canceled)

13. A method for operating a hybrid electric motor vehicle on a driving route, wherein the hybrid electric motor vehicle has an electric drive unit and a combustion-engine-powered drive unit, the method comprising:
dividing the driving route into route segments;
performing rule-based classification of the route segments as first route segments which are to be driven along electrically or second route segments which are drivable along in hybrid mode;
predicting an amount of electrical energy which is necessary for the first route segments and is to be provided by an electrical energy store of the electric drive unit;
determining residual energy for the second route segments as a function of the electrical energy which is required for the first route segments; and
performing optimization-based apportioning of the electrical energy to the second route segments while minimizing fuel consumption of a combustion engine of the combination-engine-powered drive unit, as a function of the residue energy of the electrical energy store and limiting start/stop processes of the combustion engine.

14. The method according to claim 13, wherein:
in order to operate the hybrid electric motor vehicle on the driving route, an optimum control function for the drive units of the hybrid electric vehicle is determined and an optimization function which minimizes the fuel consumption is executed globally over the route segment, and
a rule-based definition of a degree of freedom, which prevents the optimization-based apportioning of the electrical energy, and a cost function for the start/stop processes are taken into account during execution of the optimization function on specific route segments.

15. The method according to claim 13, wherein:
the driving route is divided into the route segments in accordance with navigation data of a navigation system of the hybrid electric vehicle.

16. The method according to claim 13, wherein:
at least one of a driving route-segment-specific legal specification or a driver's-request-specific input is taken into account for the rule-based classification of the route segments.

17. The method according to claim 13, wherein:
at least one condition which relates to the driving route, a route-segment-specific condition of a roadway, a route-segment-specific gradient of the roadway, or a route-segment-specific speed limit is additionally taken into account in the optimization-based apportioning of the electrical energy.

18. The method according to claim 17, wherein the at least one condition comprises at least one of a route-segment-specific condition of a roadway, a route-segment-specific gradient of the roadway, or a route-segment-specific speed limit.

19. The method according to claim 13, wherein:
at least one ambient condition an ambient temperature, a time of day, or a weather condition is additionally taken into account in the optimization-based apportioning of the electrical energy.

20. The method according to claim 19, wherein the at least one ambient condition comprises at least one of an ambient temperature, a time of day, or a weather condition.

21. The method according to claim 13, wherein:
at least one of a physical model of the electric drive unit or a physical model of the combustion-engine-powered drive unit of the hybrid electric motor vehicle is additionally taken into account in the optimization-based apportioning of the electrical energy.

22. The method according to claim 13, wherein:
high-frequency shifting processes for a transmission of the hybrid electric motor are limited during the optimization-based apportioning of the electrical energy.

23. The method according to claim 13, wherein:
a predetermined, requested final state of charge of the electrical energy store at the end of the driving route is additionally taken into account in the optimization-based apportioning of the electrical energy.

24. The method according to claim 13, wherein:
a driving style of a driver of the hybrid electric motor vehicle is additionally taken into account during the optimization-based apportioning of the electrical energy.

25. A control device for a hybrid electric motor vehicle, wherein the control device is configured to carry out the method according to claim 13.

26. A hybrid electric motor vehicle comprising:
an electric drive unit;
a combustion-engine-powered driving unit; and
a control device according to claim 25.
